(19) United States
(12) Patent Application Publication
(10) Pub. No.: US 2011/0092229 A1
(43) Pub. Date: Apr. 21, 2011

(54) METHOD AND SYSTEM FOR ENHANCED CELL-FACH/PCH DOWNLINK RECEIVER

(76) Inventors: Li Fung Chang, Holmdel, NJ (US); Bin Liu, San Diego, CA (US)

(21) Appl. No.: 12/603,304

(22) Filed: Oct. 21, 2009

(51) Int. Cl. H04W 68/00

(52) U.S. Cl. 455/458

(57) ABSTRACT

A UE in an URA_PCH state or a Cell_PCH state receives a HS-PDSCH without an associated HS-SCCH. No dedicated H-RNTI is assigned to the UE. The received HS-PDSCH is separately processed using one or more different predetermined transport format. The different predetermined transport formats are identified from associated HS-DSCH paging system information block. The UE starts blindly processing the received HS-PDSCH by determining a set of configuration parameters according to a first transport format of the identified predetermined transport formats. One or more associated device components such as hardware components of the UE are configured using the determined set of configuration parameters. The configured device components are used to perform HARQ processing, IR combining and/or Turbo decoding on the received HS_PDSCH without associated HS_SCCH. The UE continuously processes the received HS-PDSCH using the next available predetermined transport format when a CRC test completes with an error.

### CROSS-REFERENCE TO RELATED APPLICATIONS/INCORPORATION BY REFERENCE

This application makes reference to:
U.S. patent application Ser. No. ______ (Attorney Docket No. 20700US01) filed on even date herewith;
U.S. patent application Ser. No. ______ (Attorney Docket No. 20701US01) filed on even date herewith;
U.S. Patent Application Ser. No. 61/242,524 (Attorney Docket No. 20702US01) filed on Sep. 15, 2009;
U.S. patent application Ser. No. 12/573,803 (Attorney Docket No. 20702US02) filed on Oct. 5, 2009;
U.S. patent application Ser. No. ______ (Attorney Docket No. 20703US01) filed on even date herewith;
U.S. Patent Application Ser. No. 61/246,797 (Attorney Docket No. 20705US01) filed on Sep. 29, 2009;
U.S. patent application Ser. No. ______ (Attorney Docket No. 20705US02) filed on even date herewith;
U.S. patent application Ser. No. ______ (Attorney Docket No. 20706US01) filed on even date herewith;
U.S. patent application Ser. No. ______ (Attorney Docket No. 20707US01) filed on even date herewith;
U.S. Patent Application Ser. No. 61/242,554 (Attorney Docket No. 20708US01) filed on Sep. 15, 2009;
U.S. patent application Ser. No. ______ (Attorney Docket No. 20708US02) filed on even date herewith;
U.S. patent application Ser. No. ______ (Attorney Docket No. 20709US01) filed on even date herewith;
U.S. patent application Ser. No. ______ (Attorney Docket No. 20710US01) filed on even date herewith;
U.S. patent application Ser. No. 12/543,283 (Attorney Docket No. 20711US01) filed on Aug. 18, 2009;
U.S. patent application Ser. No. ______ (Attorney Docket No. 20712US01) filed on even date herewith; and
U.S. patent application Ser. No. 12/577,080 (Attorney Docket No. 20713US01) filed on Oct. 9, 2009.

Each of the above stated applications is hereby incorporated herein by reference in its entirety.

### FIELD OF THE INVENTION

Certain embodiments of the invention relate to signal processing for communication systems. More specifically, certain embodiments of the invention relate to a method and system for enhanced Cell-FACH/PCH downlink receiver.

### BACKGROUND OF THE INVENTION

Wideband Code Division Multiple Access (WCDMA) mobile wireless systems have enjoyed widespread uptake of high-quality circuit-switched applications like voice and video telephony. However, they have yet to deliver to the vision of a truly ubiquitous mobile data primarily due to the absence of an efficient high-speed-packet-switched data transmission platform. Data services like mobile Internet access require asymmetric packet switched networks to best utilize the available spectrum in a multiuser environment.

High-speed downlink packet access (HSDPA) is a packet-based data service in W-CDMA downlink with theoretical peak data rates of 14.4 Mbps or higher by utilizing adaptive modulation and coding (AMC), hybrid ARQ (HARQ), and fast MAC scheduling. HSDPA offers high-speed downlink shared channels (HS-DSCH) that may be shared efficiently among multiple users. Using these channels, HSDPA systems may provide excellent packet-switched data services to several users simultaneously and efficiently.

To implement the HSDPA feature, three new physical channels, High Speed physical Downlink-Shared Channel (HS-PDSCH), High-speed Shared Control Channel (HS-SCCH), and Uplink High-Speed Dedicated Physical Control Channel (HS-DPCCH), are introduced in the physical layer specifications to enable HS-DSCH transmission. The HS-SCCH is a downlink control channel that is utilized to inform mobile devices, also called user equipment, when HSDPA data carried over the HS-PDSCH is scheduled for them, and how they may receive and decode the HSDPA data. Up to four HS-SCCH may be observed for each mobile device. The mobile devices needs to decode the HS-SCCH that carries control information such as modulation scheme, number of physical channels, transport block format, and HARQ information, for HS-PDSCH before it gets decoded on the HS-PDSCH. The HS-DPCCH is an uplink control channel used by the mobile devices to report the downlink channel quality and/or request packet retransmissions.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for an enhanced Cell-FACH/PCH downlink receiver, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram of an exemplary HSDPA enabled communication system that is operable to facilitate HS_DSCH reception in enhanced Cell-FACH/PCH states, in accordance with an embodiment of the invention.

FIG. 2 is a block diagram illustrating an exemplary receiver that is operable to receive HS_DSCH in enhanced Cell-FACH/PCH states, in accordance with an embodiment of the invention.

FIG. 3 is a flow chart illustrating an exemplary HS_DSCH reception operation in a Cell-FACH state, in accordance with an embodiment of the invention.

FIG. 4 is a flow chart illustrating exemplary FACH data processing, in accordance with an embodiment of the invention.

FIG. 5 is a flow chart illustrating an exemplary HS_DSCH reception process in a CELL_PCH/URA_PCH state, in accordance with an embodiment of the invention.

FIG. 6 is a flow chart illustrating an exemplary HS_DSCH reception process in a CELL_PCH/URA_PCH state, in accordance with an embodiment of the invention.

FIG. 7 is a flow chart illustrating an exemplary HS_PDSCH decoding procedure in a CELL_PCH/URA_PCH state without associated HS_SCCH, in accordance with an embodiment of the invention.

### DETAILED DESCRIPTION OF THE INVENTION

Certain embodiments of the invention may be found in a method and system for continuous packet connectivity. In various embodiments of the invention, an user equipment (UE) is operable to receive a HS-PDSCH without an associated HS-SCCH. The UE is in an UMTS Radio Access Paging Channel (URA_PCH) state or a Cell Paging Channel (Cell_PCH) state. In instances where no dedicated H-RNTI is assigned to the UE, the received HS-PDSCH may be separately processed without an associated HS-SCCH using one or more different predetermined transport formats. The UE may be operable to identify or receive information on the one or more different predetermined transport format from associated HS_DSCH paging system information block. The UE may start blindly processing the received HS-PDSCH by determining a set of configuration parameters according to a first transport format of the identified one or more different predetermined transport formats. One or more associated device components of the UE may be configured using the determined set of configuration parameters. The UE may be operable to utilize the configured one or more device components, for example, hardware components, to perform HARQ processing and/or Turbo decoding on the received HS_PDSCH without associated HS_SCCH. The UE may be operable to perform incremental (IR) on the resulting HARQ processed HS_PDSCH using the configured one or more device components. The IR combined HS_PDSCH may be further processed for Turbo decoding. The UE may be operable to perform a CRC test on the resulting Turbo decoded HS_PDSCH. In instances where the CRC test completes with an error, the UE may be operable to continuously process the received HS-PDSCH using the next available predetermined transport format.

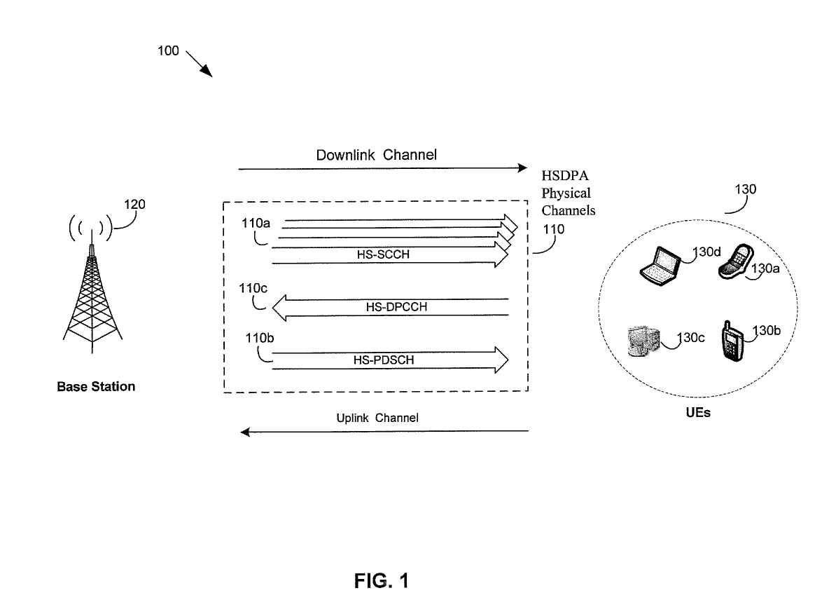

FIG. 1 is a diagram of an exemplary HSDPA enabled communication system that is operable to facilitate receiving HSDPA data in enhanced Cell-FACH/PCH states, in accordance with an embodiment of the invention. Referring to FIG. 1, there is shown a plurality of HSDPA channels 110, of which HS-SCCHs 110a, a HS-DPCCH 110b and a HS-PDSCH 110c are illustrated, a base station 120, a plurality of user equipments (UEs) 130, of which UEs 130a-130d are illustrated.

In 3rd Generation Partnership Project (3GPP) standard, the HSDPA feature may be implemented using a plurality of HS-DSCHs that may be shared among the plurality of UEs 130 in a HSDPA communication. Three HSDPA physical channels, namely, the HS-SCCH 110a, the HS-PDSCH 110b and the HS-DPCCH 110c, enable HS-DSCH transmission. The HS-SCCH 110a is a downlink control channel that carries Layer 1 (L1) control signaling to the plurality of UEs 130. The HS-SCCH 110 may be used to schedule each of the plurality of UEs 130 in the cell on a certain code and time resource. The HS-SCCH 110a may comprise control information such as, for example, channelization codes, modulation schemes, packet data unit size and format, and/or Hybrid Automatic Transmission Request (HARQ) process information. The HS-SCCH 110a may be utilized to inform the plurality of UEs 130 when HSDPA data may be scheduled over the HS-PDSCH 110b, and how each of the plurality of UEs 130 may receive and decode the scheduled HSDPA data. The HS-PDSCH 110b is a downlink data channel to the plurality of UEs 130 and may be used to carry specific messages. The HS-DPCCH 110c is an uplink control channel that carries, for example, downlink channel quality reports and/or request packet retransmissions from the plurality of UEs 130 to the base station 120.

The base station 120 may comprise suitable logic, circuitry, interfaces and/or code that may be operable to perform air interface processing and schedule communication resources in both uplink communications and downlink communications for various UEs such as the UE 130a in a timely manner. The base station 120 may be operable to support HSDPA and/or other downlink communication technologies. Various algorithms may be used by the base station 120 to determine which UE may receive a data packet and at what time the receiving may occur. In instances where HSDPA is active, results of the determination may be reported to, for example, the UE 130a, via the HS-SCCH 110a. The base station 120 may be operable to transmit a HS-SCCH such as the HS-SCCH 110a to notify the UE 130a of the control information for the next data transmission over an associated HS-PDSCH such as the HS-PDSCH 110b. In this regard, the base station 120 may be operable to manage a HS-PDSCH transmission via a legacy HS-SCCH operation or a HS-SCCH-less operation. In the legacy HS-SCCH operation, the base station 120 may be operable to transmit a HS-SCCH with every HS-PDSCH transmission. In the HS-SCCH-less operation, the base station 120 may perform an initial HS-PDSCH transmission without signaling an associated HS-SCCH. The associated HS-SCCH may be transmitted in subsequent HS-PDSCH retransmissions. The utilization of the HS-SCCH-less operation may reduce the HS-SCCH signaling overhead and save UE battery consumption. In either the legacy HS-SCCH operation or the HS-SCCH-less operation, the base station 120 may be operable to allow the UE 130a to receive HSDPA data in each of various Radio Resource Control (RRC) states such as, for example, a Cell Forward Access Channel (Cell_FACH) state, a Cell Paging Channel (Cell_PCH) state, a UMTS Radio Access Paging Channel (URA_PCH) state, and/or a Radio Resource Control (RRC) connected (Cell_DCH) state.

The base station 120 may be operable to broadcast, for example, two system information groups, namely, the HS_DSCH common system information and HS_DSCH paging system information. The HS_DSCH common system information may be configured for HS_DSCH reception in CELL_FACH state and/or transition from an idle mode to a RRC connected mode. The HS_DSCH common system information may comprise system information such as, for example, CCCH mapping information, Signaling Radio Bearer 1 (SRB1) mapping information, common MAC-ehs reordering queue list, HS-SCCH system information, HARQ system information, common H-RNTI, and BCCH specific H-RNTI. Up to, for example, 4 HS-SCCHs may be supported per cell. The common H-RNTIs and BCCH specific H-RNTI may be allocated as temporary identifiers for specific UEs by the base station 120. The base station 120 may be operable to broadcast HS_DSCH paging system information for HS_DSCH reception in URA_PCH state or CELL_PCH state. The HS_DSCH paging system information may comprise downlink scrambling code that is applied to HS-DSCH and/or HS-SCCH, Paging Indicator Channel (PICH) information, HS_PDSCH channelization code, number of PCCH transmission, and transport block size list. The Number of PCCH transmission indicates number of sub-frames that are used to transmit the PAGING TYPE 1 message. Up to, for example, 5 sub-frames may be used to transmit the PAGING TYPE 1 message. The transport block size list provides index of the transport block sizes (TBSs), for example, from 1 (TBS=137) to 32 (TBS=509).

A UE such as the UE 130a may comprise suitable logic circuitry, interfaces and/or code that may be operable to communicate radio frequency signals with the base station 120 utilizing, for example, HSDPA technology that is specified in the UMTS Radio Access Network (UTRAN). In HSDPA reception, the UE 130a may be operable to detect relevant control information on a HS-SCCH such as the HS-SCCH 110a for receiving an associated HS-PDSCH transmission from the base station 120. The UE 130a may be in one of a plurality of RRC states depending on the user activity. The RRC states may comprise an idle mode state, a URA_PCH state, a Cell_PCH state, a Cell_FACH state and a cell dedicated channel (Cell_DCH) state, which are listed in order of increasing user activity. In this regard, the UE 130a may be operable to receive HSDPA data in Cell_DCH state as well as in Cell_FACH, Cell_PCH and URA_PCH state. To receive designated downlink HS-DSCH transmissions in the Cell_FACH, the Cell_PCH and/or the URA_PCH state, an H-RNTI may be needed or required for the UE 130a to decode a HS-SCCH.

In 3GPP standard, 4 HS-SCCHs may be supported per cell. An H-RNTI that is used in Cell_FACH state, Cell_PCH state and/or URA_PCH state may be different from an H-RNTI that is used in Cell_DCH state. The Cell_DCH state is a dedicated RRC state. The H-RNTI that is used in the Cell_DCH state is called a dedicated H-RNTI. The Cell FACH state is a common RRC state. The H-RNTI that is used to transit the UE 130a to the Cell_FACH state from an idle state is called a common H-RNTI. The common H-RNTI may also be utilized in Cell_PCH state and URA_PCH state. The UE 130a may be operable to have either a common H-RNTI or a dedicated H-RNTI depending on an associated RRC state. The UE 130a may be operable to monitor two H-RNTIs, namely, a common/dedicated H-RNTI and a BCCH specific H-RNTI, simultaneously, to support HS_DSCH reception in Cell_DCH state as well as in Cell_FACH, Cell_PCH state and URA_PCH state. The UE 130a may be operable to monitor a BCCH and a CCCH, simultaneously, using a BCCH specific H-RNTI for BCCH associated HS-SCCH detection and a common/dedicated H-RNTI for CCCH associated HS-SCCH detection, respectively. The UE 130a may be operable to concurrently decode a HS-SCCH associated with the BCCH and each of, for example, four HS-SCCHs associated with the CCCH in the cell using a BCCH specific H-RNTI and a common/dedicated H-RNTI, respectively. An associated HS-PDSCH may be decoded for the detected HS-SCCH. A reliable HS-SCCH may be determined from the detected HS-SCCH associated with the BCCH and up to four HS-SCCHs associated with the CCCH. An HS-PDSCH associated with the determined reliable HS-SCCH may be used for HS-DSCH reception.

In operation, a UE such as the UE 130a may be operable to receive HSDPA data in an RRC state such as a Cell_DCH state, a Cell_FACH state, a Cell_PCH state and/or a URA_PCH state. In this regard, the UE 130a may be operable to monitor two H-RNTIs, namely, a common/dedicated H-RNTI and a BCCH specific H-RNTI, simultaneously, for HS-SCCH detection. The UE 130a may be operable to extract a BCCH specific H_RNTI from system information broadcast to be used for HS-SCCH detection on the BCCH. The UE 130a may be operable to use the extracted BCCH specific H-RNTI and a common/dedicated H-RNTI to concurrently decode a HS-SCCH associated with the BCCH and each of HS-SCCHs associated with the CCCH in the cell, respectively. An associated HS-PDSCH may be decoded for the detected HS-SCCH corresponding to BCCH or CCCH. A reliable HS-SCCH may be determined from the detected HS-SCCHs. An HS-PDSCH associated with the determined reliable HS-SCCH may be utilized for HS_DSCH reception.

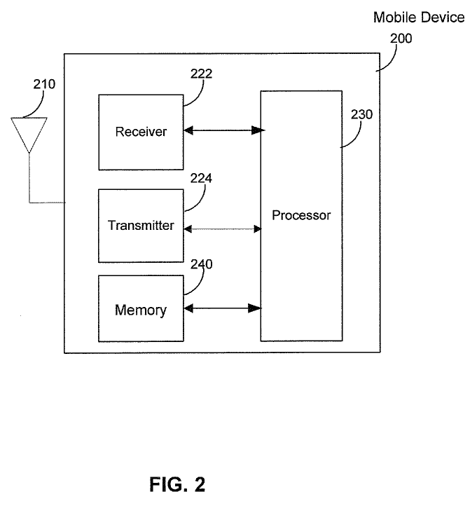

FIG. 2 is a block diagram illustrating an exemplary receiver that is operable to receive HS_DSCH in enhanced Cell-FACH/PCH states, in accordance with an embodiment of the invention. Referring to FIG. 2, there is shown a HSDPA enabled mobile device 200. The HSDPA enabled mobile device 200 comprises an antenna 210, a receiver 222, a transmitter 224, a processor 230 and a memory 240.

The antenna 210 may comprise suitable logic, circuitry, interfaces and/or code that may be operable to receive and process RF signals received, for example, over a LTE/E-UTRA air interface. The antenna 210 may be operable to communicate the received RF signals to the receiver 222 for further processing.

The receiver 222 may comprise suitable logic, circuitry, interfaces and/or code that may be operable to facilitate the reception of wireless signal over, for example, LTE/E-UTRA air interface. The received signal may be communicated and received using, for example, HSDPA technology. In HSDPA reception, the receiver 222 may be operable to initially read the system information broadcasted by the network via the base station 120. The receiver 222 may be operable to determine whether to camp on the cell or not. Once the receiver 222 camps on the cell, the receiver 222 may also read the system information that may be required for making a connection to the network via the base station 120. Then the receiver 222 may be operable to send, for example, a connection request message to the network on, for example, a Random Access Channel (RACH). From that point onwards the receiver 222 may be enabled to utilize HS-DSCH channels, namely, HS-DSCH mapped on HS-SCCH and HS-PDSCH, in the downlink communication.

The receiver 222 may be operable to detect control information on a HS-SCCH such as the HS-SCCH 110a for receiving an associated HS-PDSCH transmission from the base station 120. The HS-PDCH transmission may be communicated via a legacy HS_SCCH operation and a HS-SCCH-less operation as specified in 3GPP standard. The HS-SCCH-less operation may comprise an initial transmission without an associated HS-SCCH, and two successive transmissions with associated HS-SCCH. Depending on the user activity of the HSDPA enabled mobile device 200, the receiver 222 may be in one of a plurality of RRC states comprising an idle mode state, URA_PCH state, Cell_PCH state, Cell_FACH state and Cell_DCH state. The receiver 222 may be operable to determine an allocated H-RNTI so as to decode the HS-SCCH 110a. The receiver 222 may be operable to read system information broadcast and extract a BCCH specific H-RNTI from the system information broadcast for BCCH associated HS-SCCH detection. The receiver 222 may be operable to monitor a HS-SCCH associated with the BCCH and each of HS-SCCHs associated with the CCCH based on the extracted BCCH specific H-RNTI and a common/dedicated H-RNTI, simultaneously. For example, in instances where the receiver 222 is in the Cell-FACH state, the Cell_PCH state or the URA_PCH state, the receiver 222 may be operable to determine a reliable HS-SCCH by simultaneously monitoring a HS-SCCH using a BCCH specific H-RNTI and up to four HS-SCCHs using a common H-RNTI in the cell. In instances where the receiver 222 is in the Cell_DCH state, the receiver 222 may be assigned a dedicated H-RNTI and uses the dedicated H-RNTI as user ID for HS-SCCH detection.

The receiver 222 may be operable to simultaneously monitor a HS-SCCH using a BCCH specific H-RNTI and up to four HS-SCCHs using a common H-RNTI or dedicated H-RNTI in the cell in the cell so as to determine a reliable HS-SCCH to the receiver 222. For each associated RRC state, the receiver 222 may be operable to evaluate up to five HS-SCCH pairs using a BCCH specific H-RNTI and a dedicated/common H-RNTI, respectively, so as to determine a reliable HS-SCCH. The determined HS-SCCH may be associated with the BCCH or the CCCH in the cell. For each transmission time interval (TTI), the receiver 222 may be operable to concurrently monitor a HS-SCCH associated with BCCH specific H-RNTI and up to 4 HS-SCCHs associated with a dedicated/common H-RNTI, simultaneously. An HS-PDSCH that is associated with the determined reliable HS-SCCH may be utilized for HS-DSCH reception.

The transmitter 224 may comprise suitable logic, circuitry, interfaces and/or code that may be operable to facilitate signals to be transmitted over, for example, LTE/E-UTRA air interface. The signals may be communicated and transmitted using, for example, HSDPA.

The processor 230 may comprise suitable logic, circuitry, interfaces and/or code that may be operable to manage and/or control operations of the HSDPA enabled mobile device 200. The processor 230 may be operable to execute various applications such as voice communication on the HSDPA enabled mobile device 200. The processor 230 may be operable to interact with the receiver 222 to process the received signals for output to present to users. The processor 230 may also be operable to interact with the transmitter 224 to facilitate signal transmission to the base station 120. The signals may be communicated and transmitted using, for example, HSDPA technology.

The memory 240 may comprise suitable logic, circuitry, interfaces and/or code that may be operable to store information such as executable instructions and data that may be utilized by the processor 230 as well as the receiver 222 and the transmitter 224. The executable instructions may comprise algorithms that may be applied to various signal processes such as baseband signal processing. The memory 240 may comprise RAM, ROM, low latency nonvolatile memory such as flash memory and/or other suitable electronic data storage.

In an exemplary operation, the receiver 222 may be operable to receive signals via the antenna 210. The signals may be communicated using HSDPA technology. The received signals may comprise one or more HS-HCCHs and associated HS-PDSCHs. The receiver 222 may be operable to detect control information on the received HS-SCCHs for HS-PDSCH reception. The receiver 222 may be in an idle mode state, an URA_PCH state, a Cell_PCH state, Cell_FACH state and/or a cell Cell_DCH state.

The receiver 222 may be operable to extract a BCCH specific H-RNTI from the system information broadcast for BCCH associated HS-SCCH detection. The receiver 222 may be operable to concurrently perform BCCH associated HS-SCCH detection and CCCH associated HS-SCCH detection using the extracted BCCH specific H-RNTI and a common/dedicated H-RNTI, respectively. An associated HS-PDSCH may be decoded for the detected HS-SCCH. The receiver 222 may be operable to determine a reliable HS-SCCH from the detected HS-SCCHs. The reliable HS-SCCH may be determined by evaluating a HS-SCCH on the BCCH and each of HS-SCCHs associated with the CCCH. A HS-PDSCH that is associated with the determined reliable HS-SCCH may be applied for HS-DSCH reception. The receiver 222 may be operable to communicate with the processor 230 for the received HS-DSCH to support various applications such as voice or data communication on the HSDPA enabled mobile device 200. The processor 230 may also be operable to communicate with the transmitter 224 for signal transmission to the base station 120.

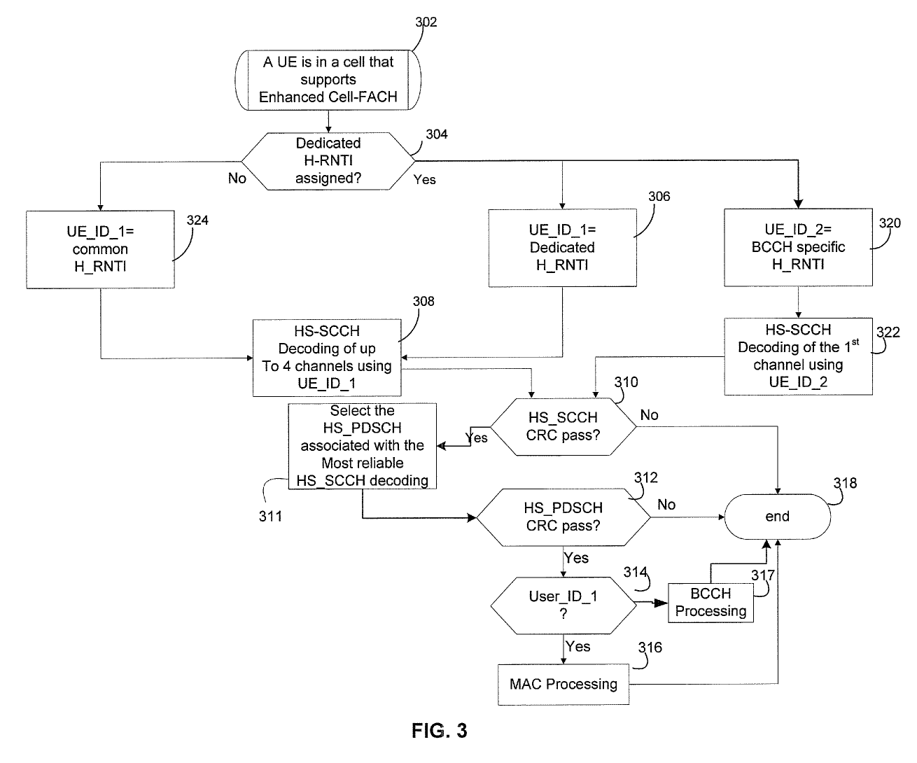

FIG. 3 is a flow chart illustrating an exemplary HS_DSCH reception operation in a Cell-FACH state, in accordance with an embodiment of the invention. Referring to FIG. 3, the exemplary steps start in step 302, where the receiver 222 is in a cell that supports HS-DSCH reception in Cell-FACH state. HS-DSCH reception is configured in the system information broadcast. The receiver 222 is enabled for HS-DSCH reception in Cell-FACH state. The receiver 222 may be operable to read the broadcast system configuration information and receive common control channel (CCCH) or broadcast control channel (BCCH) via HS-PDSCH. The received CCCH may comprise signaling or control information to the receiver when there is no RRC connection. In step 304, it may be determined whether the receiver 222 may be assigned a dedicated H-RNTI. In instances where a dedicated H-RNTI is assigned to the receiver 222 by the base station 120, then in step 306, where the receiver 222 may be operable to set parameter UE_ID_1 to be equal to the assigned dedicated H_RNTI.

In step 304, in instances where a dedicated H-RNTI is not assigned to the receiver 222 by the base station 120, then in step 324, the receiver 222 may be operable to use a common H-RNTI as a UE_ID_1 for HS-SCCH decoding.

In step 308, the receiver 222 may be operable to utilize the assigned dedicate H-RNTI from step 306 or a common H-RNTI from step 324 as UE_ID_1 to decode each of HS-SCCHs supported in the cell.

In step 320, the receiver 222 may be operable to extract a BCCH specific H-RNTI from system broadcast information and the receiver 222 may be operable to set parameter UE_ID_2 to be equal to the extracted BCCH specific H_RNTI. In step 322, the receiver 222 may be operable to utilize the first indexed channelization code in HS-SCCH channelization codes that are received in the HS-DSCH common system information for BCCH associated HS-SCCH detection.

The receiver 222 may be operable to concurrently perform step 308 and step 320 to decode up to 4 HS-SCCHs associated with the UE_ID_1 and to decode HS-SCCH associated with UE_ID_2, respectively.

In step 310, in instances where the resulting decoded HS-SCCHs do not pass a corresponding CRC test, then the exemplary steps may end in step 318. In step 310, in instances where more than two HS_SCCH detections have passed the CRC test, then the decoding of the HS_PDSCH may be selected based on the one associated with the most reliable detection of the HS_SCCH. The most reliable detection of the HS_SCCH may be determined based on measurements such as Viterbi metrics. In step 312, it may be determined whether the HS_PDSCH associated with the corresponding most reliable decoded HS-SCCH may pass a corresponding CRC test. In instances where the associated HS_PDSCH does not pass a corresponding CRC check, then the exemplary steps may end in step 318.

In step 312, in instances where the associated HS_PDSCH passes a corresponding CRC test, then in step 314, the receiver 222 may be operable to determine whether the HS-PDSCH may associate with UE_ID_1 or UE_ID_2. In instances where the HS-PDSCH may associate with a UE_ID_1, then in step 316, the receiver 222 may be operable to forward data of the HS-PDSCH for MAC processing/FACH data processing. In this regard, the data of the HS-PDSCH may be processed over a corresponding transport channel (TrCH) according to a specified transport format, namely, a transport format block (TFB) or transport block set size.

In instances where the HS-PDSCH may associate with a UE_ID_2, then in step 317, the receiver 222 may be operable to forward data of the decoded HS-PDSCH for BCCH processing.

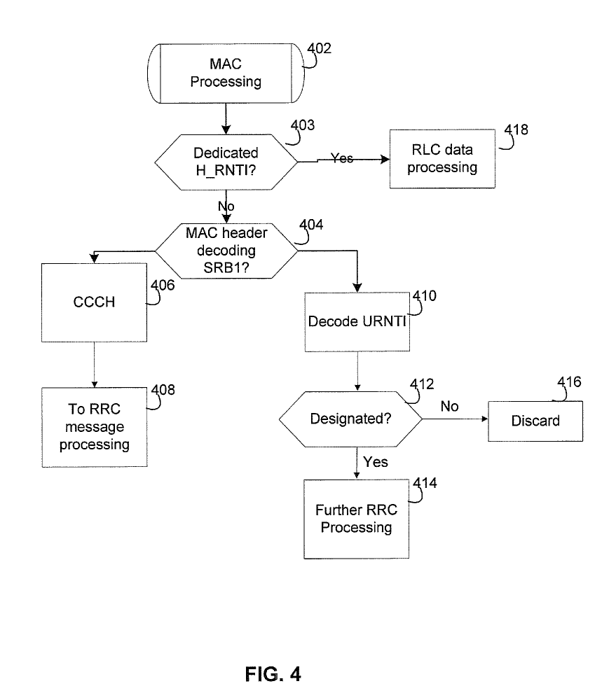

FIG. 4 is a flow chart illustrating an exemplary FACH data processing, in accordance with an embodiment of the invention. Referring to FIG. 4, the exemplary steps start in step 402, where HS-DSCH reception is configured in the system information broadcast. The receiver 222 is enabled for HS-DSCH reception in cell-FACH state. The receiver 222 may be operable to read the broadcast system information and receive CCCH or BCCH via HS-PDSCH. The UE ID (H-RNTI) that is used for HS-SCCH detection or decoding may be different between the CCCH associated HS-PDSCH and the BCCH associated HS-PDSCH. The HS-SCCH channelization codes in the broadcast system information may be used for CCCH associated HS-SCCH detection. The 1st indexed channelization code of the HS-SCCH channelization codes received in the broadcast system information may be used for BCCH associated HS-SCCH detection. Control information from the detected HS-SCCH may be utilized for corresponding HS-PDSCH reception.

In step 403, in instances where the received HS-PDSCH is associated with a dedicated H_RNTI, in step 418 the receiver 222 may forward the decoded HS_DSCH data for RLC processing.

In step 403, in instances where the received HS-PDSCH is associated with a common H_RNTI which carries FACH data, then in step 404, the receiver 222 may determine from the MAC header a signaling message (SRB1) or a CCCH associated with the payload of the received HS-PDSCH. In step 406, the receiver 222 may be operable to forward the data of the received HS-PDSCH for RRC message processing in step 408. In step 408, the receiver 222 may be operable to perform RRC message processing on the data of the received HS-PDSCH. In step 410, the receiver 222 may be operable to use the BCCH specific H-RNTI as UE ID for HS-SCCH detection.

In step 410, the receiver 222 may be operable to decode the UTRAN TNTI (U-RNTI) in corresponding MAC-c header to identify designated MAC PDUs for HS-DSCH reception in cell-FACH state. In step 412, it may be determined whether the received MAC PDUs may be designated. In instances where the received MAC PDUs are designated, then in step 414, the receiver 222 may perform further RRC processing on the received designated MAC PDUs. In step 412, in instances where the received MAC PDUs are not desired or designated, then in step 416, the receiver 222 may discard the received MAC PDUs.

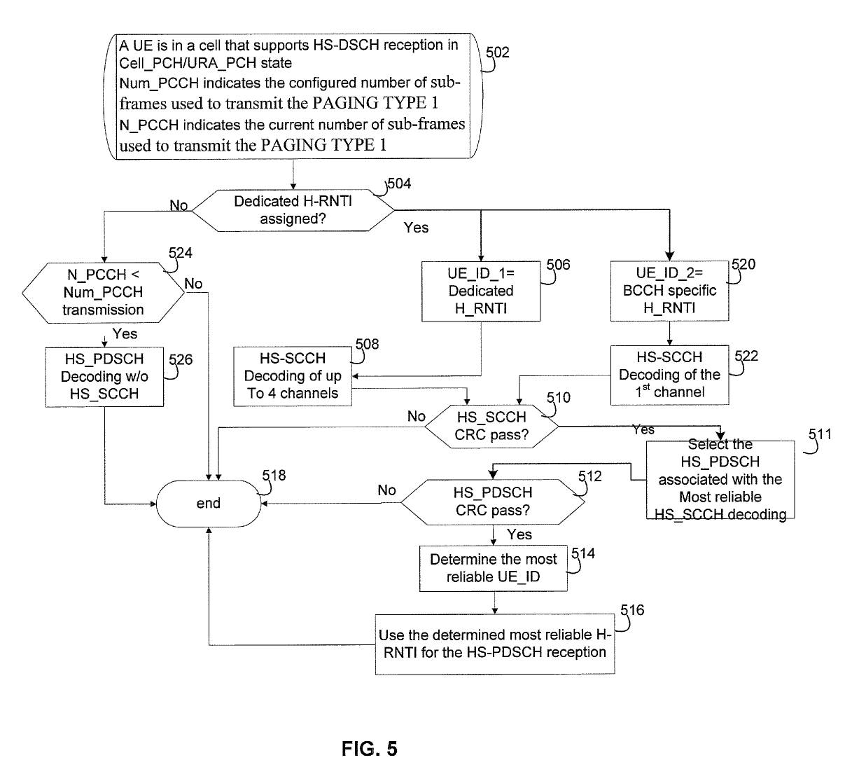

FIG. 5 is a flow chart illustrating an exemplary HS_DSCH reception process in a CELL_PCH/URA_PCH state, in accordance with an embodiment of the invention. Referring to FIG. 5, the exemplary steps start in step 502, where the receiver 222 is in a cell that supports HS-DSCH reception in Cell_PCH/URA_PCH state. HS-DSCH reception is configured in the system information broadcast. The receiver 222 is enabled for HS-DSCH reception in Cell_PCH/URA_PCH state. The receiver 222 may be operable to read the broadcast system information and receive CCCH or BCCH via HS-PDSCH. Parameters Num_PCCH and N_PCCH indicate the configured and the current PCCH transmission, which indicates sub-frames used to transmit the PAGING TYPE 1. In step 504, it may be determined whether the receiver 222 may be assigned a dedicated H-RNTI. In instances where a dedicated H-RNTI is assigned to the receiver 222 by the base station 120, then in step 506, the receiver 222 may be operable to set parameter UE_ID_1 to be equal to the assigned dedicated H_RNTI.

In step 508, the receiver 222 may be operable to utilize the assigned dedicate H-RNTI to decode each of HS-SCCHs supported in the cell. For example, up to four HS-SCCHs may be supported in the cell. In step 510, it may be determined whether the resulting decoded HS-SCCHs may pass a corresponding CRC test. In instances where the resulting decoded HS-SCCHs pass a corresponding CRC test, then in step 511, the most reliable HS-SCCH detection is selected based on criterion such as Viterbi metrics. In step 512, it may be determined whether HS_PDSCHs associated with the corresponding most reliable decoded HS-SCCHs may pass a corresponding CRC test, In instances where the associated HS_PDSCHs pass a corresponding CRC test, then in step 514, the receiver 222 may be operable to determine the most reliable UE ID. In step 516, the receiver 222 may be operable to use the determined most reliable UE ID for corresponding HS-PDSCH reception. The exemplary steps may end in step 518.

In step 504, in instances where a dedicated H-RNTI is assigned to the receiver 222 by the base station 120, then in step 520, the receiver 222 may be operable to extract a BCCH specific H-RNTI from a BCCH carried by a HS-PDSCH. The receiver 222 may be operable to set parameter UE_ID_2 to be equal to the extracted BCCH specific H_RNTI. In step 522, the receiver 222 may be operable to utilize the first indexed channelization code in HS-SCCH channelization codes that are received in the HS-DSCH common system information for BCCH associated HS-SCCH detection. The exemplary steps may continue in step 510.

In step 504, in instances where a dedicated H-RNTI is not assigned to the receiver 222 by the base station 120, then in step 524, it may be determined whether the current number of PCCH transmission (N_PCCH) is less than the configured number of PCCH transmission (Num_PCCH). In instances where the current number of PCCH transmission (N_PCCH) is less than the configured number of PCCH transmission (Num_PCCH), then in step 526, the HS_PDSCH may be decoded without HS_SCCH. The exemplary steps may end in step 518.

In step 510, in instances where the resulting decoded HS-SCCHs do not pass a corresponding CRC test, then the exemplary steps may end in step 518. In step 512, in instances where the associated HS_PDSCHs do not pass a corresponding CRC check, then the exemplary steps may end in step 518. In step 524, in instances where the current number of PCCH transmission (N_PCCH) is not less than the configured number of PCCH transmission (Num_PCCH), then the exemplary steps may end in step 518.

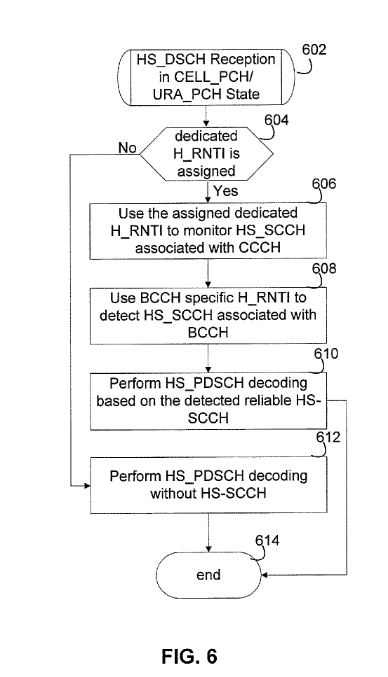

FIG. 6 is a flow chart illustrating an exemplary HS_DSCH reception process in a CELL_PCH/URA_PCH state, in accordance with an embodiment of the invention. Referring to FIG. 6, the exemplary steps start in step 602, where the receiver 222 is in a cell that supports HS-DSCH reception in Cell_PCH/URA_PCH state. HS-DSCH reception is configured in the system information broadcast. The receiver 222 is enabled for HS-DSCH reception in Cell_PCH/URA_PCH state. The receiver 222 may be operable to read the broadcast system information and receive CCCH or BCCH via HS-PDSCH. In step 604, it may be determined whether a dedicated H-RNTI is assigned to the receiver 222 by the base station 120. In instances where a dedicated H-RNTI is assigned to the receiver 222 by the base station 120, then in step 606, the receiver 222 may be operable to use the assigned dedicated H_RNTI to monitor HS_SCCH associated with CCCH. In step 608, concurrently, the receiver 222 may use BCCH specific H_RNTI to monitor HS_SCCH associated with BCCH. In step 610, the receiver 222 may be operable to determine a reliable HS-SCCH by monitoring each HS_SCCH associated with CCCH and a HS_SCCH associated with BCCH. Up to four HS-SCCHs are supported in the cell. The receiver 222 may be operable to utilize control information of the determined reliable HS-SCCH to perform HS-PDSCH decoding. The exemplary steps may end at step 614.

In step 604, in instances where a dedicated H-RNTI is not assigned to the receiver 222 by the base station 120, then in step 612, where the receiver 222 may be operable to perform HS_PDSCH decoding without an associated HS-SCCH. The exemplary steps may end at step 614.

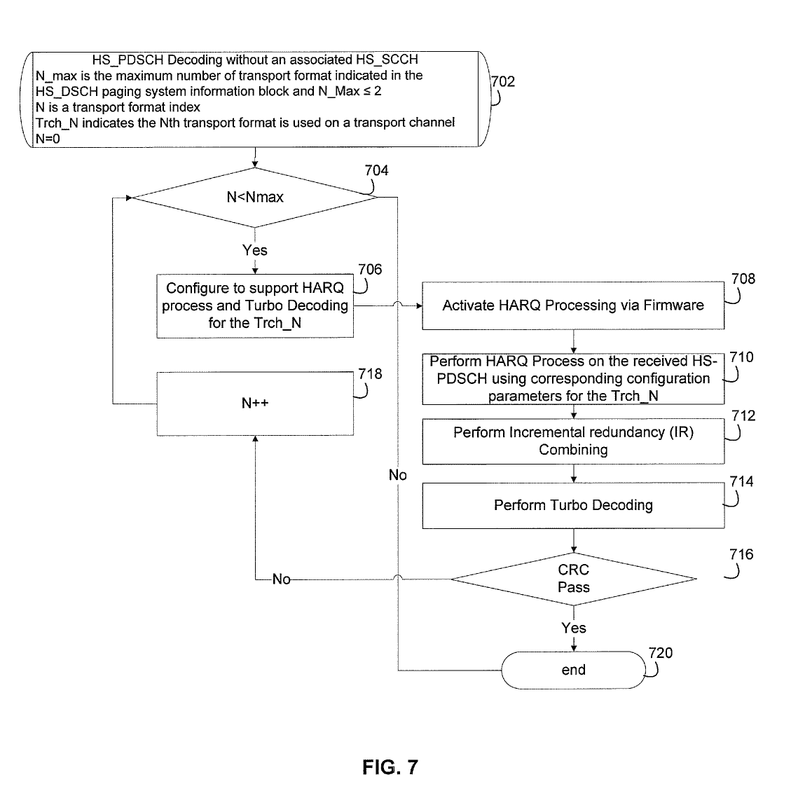

FIG. 7 is a flow chart illustrating an exemplary HS_PDSCH decoding procedure in a CELL_PCH/URA_PCH state without associated HS_SCCH, in accordance with an embodiment of the invention. Referring to FIG. 7, the exemplary HS_PDSCH decoding procedure in a CELL_PCH/URA_PCH state without associated HS_SCCH may correspond to step 526 in FIG. 5. The exemplary steps start in step 702, where the receiver 222 is in Cell_PCH/URA_PCH state. The receiver 222 receives a HS_PDSCH transmission received without associated HS_SCCH. Parameter N_max is the maximum number of transport format indicated in an associated HS_DSCH paging system information block and N_Max≦2. Parameter N is transport format index. Parameter Trch_N indicates the N^{th} transport format is used on a corresponding transport channel for MAC processing. The exemplary process may start by setting the parameter N to be equal to zero. In step 704, it may be determined whether the parameter N is less than the parameter N_Max. In instances where the parameter N is less than the parameter N_Max, then in step 706, the receiver 222 may be operable to determine a set of configuration parameters according to the N^{th} transport format over a corresponding transport channel (Trch_N). One or more device components such as hardware components of the receiver 222 may be configured using the determined set of configuration parameters so as to support HARQ processing and Turbo decoding on the received HS_PDSCH without an associated HS_SCCH. For example, each transport format is assigned to hardware components of a HARQ processor of the receiver 222 so that combining can be performed with the next sub-frame PCCH blocks and blind format decoding may be accomplished automatically by the corresponding hardware components or modules without firmware interruption. The receiver 222 may be configured to perform, for example, HARQ type 0, 1, 2, and/or 3 processing implemented in a HS-SCCH-less operation. In step 708, the configured device components may be activated for HARQ processing, for example, via firmware. In step 710, the receiver 222 may be operable to perform HARQ processing on the received HS_PDSCH via the configured device components. In step 712, the receiver 222 may be operable to perform Incremental redundancy (IR) combining on resulting HARQ processed data or blocks of the received HS_PDSCH. In step 714, the receiver 222 may be operable to perform Turbo decoding on the resulting IR combined data or blocks of the received HS_PDSCH. In step 716, it may be determined whether the resulting Turbo decoded data or blocks may pass a CRC test. In instances where the resulting Turbo decoded data or blocks may pass a CRC test, then the exemplary steps may end in step 720.

In step 716, in instances where the resulting Turbo decoded data or blocks may not pass a CRC test, then in step 718, the parameter N is increased by a step of one. The exemplary steps may return to step 706.

In step 704, in instances where the parameter N is greater than or equal to the parameter N_Max, then the exemplary steps may end in step 720.

Aspects of a method and system for continuous packet connectivity are provided. In accordance with various embodiments of the invention, a UE such as the UE 130a may be operable to concurrently detecting a HS-SCCH associated with a BCCH and each of a plurality of HS-SCCHs, for example, four HS-SCCHs, associated with a CCCH in the cell using a first UE identifier (ID) and a second UE ID, respectively. The UE 130a may be in one of a plurality of RRC states comprising a Cell_FACH state, a URA_PCH state, and a Cell_PCH state. HS-DSCH reception is configured in the system information broadcast. The UE 130a may be operable to read system information broadcast and extract a BCCH specific H-RNTI from system information broadcast. The UE 130a may be operable to use the extracted BCCH specific H-RNTI to detect an HS-SCCH associated with the BCCH. The UE 130a may be operable to decode a HS-PDSCH using the detected HS-SCCH associated with the BCCH.

In instances where the UE 130a is assigned a dedicated H-RNTI, the UE 130a may be operable to utilize the assigned dedicated H-RNTI as the second UE ID for HS-SCCH detection over the associated CCCH. In instances where the UE 130a is not assigned a dedicated H-RNTI, the UE 130a may be operable to utilize a common H-RNTI as the second UE ID for HS-SCCH detection over the associated CCCH. The UE 130a may be operable to decode an associated HS-PDSCH for each of the detected HS-SCCHs associated with the CCCH of the cell. In instances where the UE 130a is in the URA_PCH state or the Cell_PCH state, and no dedicated H-RNTI is assigned to the UE 130a by the base station 120, the UE 130a may not perform HS-SCCH detection over, for example, four HS-SCCHs associated with the CCCH of the cell. The UE 130a may be operable to decode a HS-PDSCH without an associated HS-SCCH, accordingly.

In accordance with various embodiments of the invention, a UE such as the UE 130a in an URA_PCH state or a Cell_PCH state may be operable to receive a HS-PDSCH without an associated HS-SCCH. In instances where no dedicated H-RNTI is assigned to the UE 130a, the received HS-PDSCH may be separately processed blindly using one or more different predetermined transport format. The UE 130a may be operable to identify or receive information on the one or more different predetermined transport format from associated HS_DSCH paging system information block. In 3GPP standard, two different predetermined transport formats are specified. The UE 130a may start blindly processing the received HS-PDSCH by determining a set of configuration parameters according to a first transport format of the identified one or more different predetermined transport formats. The UE 130a may be operable to configure one or more associated device components in the receiver 222 using the determined set of configuration parameters. The configured one or more device components may be, for example, hardware components, and may be used to perform HARQ processing such as, for example, HARQ type 0-3 processing specified in the HS-SCCH-less operation, and Turbo decoding. The UE 130a may be operable to use the configured one or more device components to perform HARQ processing on the received HS_PDSCH without associated HS_SCCH. An IR combining may be performed on the resulting HARQ processed HS_PDSCH via the configured one or more device components. The IR combined HS_PDSCH may be further processed for Turbo decoding using the configured one or more device components. The UE 130a may be operable to perform a CRC test on the resulting Turbo decoded HS_PDSCH. In instances where the CRC test completes with an error, the UE 130a may be operable to continuously process the received HS-PDSCH by using the next available predetermined transport format in the identified one or more different predetermined transport formats.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for enhanced Cell-FACH/PCH downlink receiver.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
performing by one or more processors and/or circuits in a user equipment (UE):
receiving a high speed physical downlink-shared channel (HS-PDSCH) without an associated high-speed shared control channel (HS-SCCH) in an UMTS Radio Access paging Channel (URA_PCH) state or a cell paging channel (Cell_PCH) state; and
separately processing said received HS-PDSCH using one or more different predetermined transport format, when said UE is not assigned a dedicated HSDPA Radio Network Temporary Identity (H-RNTI).

2. The method according to claim 1, comprising identifying said one or more predetermined transport format from associated paging system information.

3. The method according to claim 1, comprising determining a set of configuration parameters according to a first transport format of said identified one or more different predetermined transport formats.

4. The method according to claim 3, comprising configuring one or more device components of said UE using said determined set of configuration parameters for said first transport format.

5. The method according to claim 4, wherein said configured one or more device components are hardware components.

6. The method according to claim 4, comprising Hybrid automatic repeat request (HARQ) processing said received HS_PDSCH without said associated HS_SCCH via said configured one or more device components of said UE.

7. The method according to claim 6, comprising incremental redundancy (IR) combining resulting HARQ processed HS_PDSCH via said configured one or more device components of said UE.

8. The method according to claim 7, comprising Turbo decoding resulting IR combined HS_PDSCH via said configured one or more device components of said UE.

9. The method according to claim 8, comprising performing a Cyclic redundancy checksum (CRC) test on said Turbo decoded HS_PDSCH.

10. The method according to claim 9, comprising processing said received HS-PDSCH using next available transport format in said identified one or more different predetermined transport formats when said CRC test fails.

11. A system for signal processing, the system comprising:
one or more processors and/or circuits for use within a user equipment (UE), wherein said one or more processors and/or circuits are operable to receive a high speed physical downlink-shared channel (HS-PDSCH) without an associated high-speed shared control channel (HS-SCCH) in an UMTS Radio Access paging Channel (URA_PCH) state or a cell paging channel (Cell_PCH) state; and
said one or more processors and/or circuits are operable to separately process said received HS-PDSCH using one or more different predetermined transport format, when said UE is not assigned a dedicated HSDPA Radio Network Temporary Identity (H-RNTI).

12. The system according to claim 11, wherein said one or more processors and/or circuits are operable to identify said one or more different predetermined transport format from associated paging system information.

13. The system according to claim 12, wherein said one or more processors and/or circuits are operable to determine a set of configuration parameters according to a first transport format of said identified one or more different predetermined transport formats.

14. The system according to claim 13, wherein one or more processors and/or circuits are operable to configure one or more device components of said UE using said determined set of configuration parameters for said first transport format.

15. The system according to claim 14, wherein said configured one or more device components are hardware components.

16. The system according to claim 14, wherein one or more processors and/or circuits are operable to Hybrid automatic repeat request (HARQ) process said received HS_PDSCH without said associated HS_SCCH via said configured one or more device components of said UE.

17. The system according to claim 16, wherein one or more processors and/or circuits are operable to incremental redundancy (IR) combine resulting HARQ processed HS_PDSCH via said configured one or more device components of said UE.

18. The system according to claim 17, wherein one or more processors and/or circuits are operable to Turbo decode resulting IR combined HS_PDSCH via said configured one or more device components of said UE.

19. The system according to claim 12, wherein one or more processors and/or circuits are operable to perform a Cyclic redundancy checksum (CRC) test on said Turbo decoded HS_PDSCH.

20. The system according to claim 19, wherein one or more processors and/or circuits are operable to process said received HS-PDSCH using next available transport format in said identified one or more different predetermined transport format when said CRC test fails.
